(19) United States
(12) Patent Application Publication
(10) Pub. No.: US 2014/0127605 A1
(43) Pub. Date: May 8, 2014

(54) PEMFC ELECTRODE STRUCTURING

(71) Applicant: Commissariat A L'Energie Atomique Et Aux Energies Alternatives, Paris (FR)

(72) Inventors: Rémi VINCENT, Grenoble (FR); Anne-Gaëlle MERCIER, Chambery (FR)

(73) Assignee: Commissariat A L'Energie Atomique Et Aux Energies Alternatives, Paris (FR)

(21) Appl. No.: 14/062,197

(22) Filed: Oct. 24, 2013

(30) Foreign Application Priority Data
Nov. 8, 2012 (FR) 12.60601

(51) Int. Cl. H01M 4/88; H01M 8/10; H01M 4/86

(52) U.S. Cl. CPC H01M 4/8832; H01M 4/8626; H01M 8/1002
USPC 429/479; 427/115; 429/523

(57) ABSTRACT

A method of deposition, by drop-on-demand inkjet printing, of the catalytic layer of a fuel cell comprising the deposition, on a printing surface, of an ink generating substantially circular structures comprising a bead at their periphery.

### FIELD OF THE INVENTION

The present invention relates to the manufacturing of structured electrodes, by the inkjet printing technique, and more specifically by DOD (“Drop On Demand”) or microdispersing. According to the invention, structured electrodes appear in the form of substantially circular structures comprising a bead at their periphery, which result from a so-called “coffee ring” phenomenon.

The invention especially applies in the field of PEMFCs (“Polymer Electrolyte Membrane Fuel Cells”). Indeed, unexpectedly, a cell provided with such electrodes has an improved performance.

### BACKGROUND

Much research is carried out in the field of fuel cells to improve the performance and to decreasing production cost for such electrochemical devices. In particular, fuel cells are considered as a promising alternative to power sources based on the use of hydrocarbons, which are finite resources and generate an undesirable pollution by their combustion.

Fuel cells have an operation based on the oxidation of a fuel, for example, hydrogen or H₂, at the level of a first electrode called anode, combined with the reduction of oxygen or O₂, at the level of a second electrode called cathode, to generate an electric current.

Such electrodes are arranged on either side of an electrolytic proton-conductive membrane, for example, made of Nafion®, thus forming a membrane-electrode assembly or MEA. Further, gas diffusion layers or GDLs, generally made of carbon black, are arranged on either side of the MEA.

To accelerate reactions, the catalytic layers or active layers forming the electrodes contain, in addition to an ionomer advantageously of same nature as the polymer forming the membrane, a catalyst advantageously in the form of catalytic particles. A particularly efficient catalyst is platinum, which may be in the form of platinum carbon. It however has the disadvantage of being very expensive.

In practice, the electrodes of a fuel cell are deposited either on the electrolytic membrane, or on the gas diffusion layers or GDLs. Many developments have thus concerned catalyst deposition techniques and conditions, to obtain high-performance electrodes at a lower cost.

One option to decrease the production cost of such an electrode is to decrease the thickness of the catalytic layer. Thus, the DOD inkjet printing method enables to deposit a volume of a few picoliters per drop of a liquid mixture containing the catalyst. After drying and evaporation of the other ink components, only the catalyst and the ionomer remain on the printed surface.

The feasibility of this printing technique, in the context of the deposition of the active layer of a PEMFC, has been highlighted by Towne et al. (Journal of Power Sources, 171, (2007) 575-584), who have further demonstrated that this technique would provide a high-resistance and flexible deposit requiring no step of exposure to a high pressure to provide the adherence of the catalyst.

DOD inkjet printing is an extremely common method, which is for example implemented in office printing devices, which have a well-controlled technology. Towne et al. have shown that an ink containing platinum particles, deionized water to solubilize it, and a mixture of water, of ethylene glycol, and of isopropanol to adjust the viscosity and the surface tension of the drops, is compatible with DOD inkjet printing devices, and especially with printing heads.

Thus, the DOD inkjet printing method provides a high flexibility for the patterns to be printed.

Such a printing method also enables to precisely control the location of the printed drops.

On the other hand, as shown by Taylor et al. (Journal of Power Sources 171 (2007), 101-106), this method enables to increase the platinum proportion effectively used in the catalysis process of oxidation-reduction reactions. This document also reports the forming of platinum multilayer structures having a platinum concentration gradient across the deposition thickness.

Further, and as disclosed by Saha et al. (Journal of The Electrochemical Society, 158, (2011), B562-B567), it is possible to decrease the platinum load of the surface of an electrode down to 0.02 mg Pt/cm².

The use of an inkjet printing method, in particular of DOD type, however comes up against two constraints:
on the one hand, printing nozzles are sensitive to clogging by the catalytic particles contained in the ink;
on the other hand, during the drying of the drops, the catalytic particles may be inhomogeneously redistributed on the printed surface, according to a physical phenomenon called “coffee ring”: When drying, the drops leave substantially circular structures (similar to those of the drops) of uneven thickness, that is, beads or rings (“coffee stains” or “coffee rings”) at their periphery (FIG. 2).

To avoid the problem of the clogging of printing head nozzles, it is currently ascertained that the ink has a composition minimizing the risk of drying. The ink characteristics thereby have to meet strict requirements in terms of rheology, surface tension, dispersion, and volatility. Thus, and in relation with the DOD inkjet printing technique, an ink having a viscosity ranging between 1 and 10 mPa·s, a surface tension ranging between 30 and 35 rnN/m, and a particle size smaller than 10 times the size of the nozzle opening, in practice smaller than one micrometer, is advocated (Blayo; Techniques de l'ingenieur, reference J2290-2, 2007).

One of the key elements enabling to avoid the drying of ink in nozzles is the addition of a solvent having a high boiling point, commonly called humectant, such as ethylene glycol. Clayert's article (Chem. Mater., 2001, 13, 3299-3305) specifies that a mass proportion of humectant in the range between 10% and 20% of the total ink mass is necessary to avoid for the ink to dry on the printing head nozzles.

Document US 2008/0009409 describes an ink for the DOD technique containing catalyst particles having a size smaller than 200 nanometers, and where the catalyst proportion is close to 60% of the total mass of the ink.

A second problem posed to those skilled in the art in relation with DOD inkjet printing is the “coffee ring” phenomenon. As illustrated in FIG. 1, this phenomenon occurs due to a faster evaporation of the liquid at the level of triple line 6 (line at the drop—support surface—air interface) than in the central region of the drop. Thus, the particles contained in the drop are submitted to convection motions forcing them to build up on this triple line. This results in a high particle concentration on the edges of the initially-deposited drop, which generates a structure of substantially circular shape 114, having at its periphery a bead or ring 9, at the level of which catalyst particles have concentrated, conversely to center 10 of the structure where the particles are by a small quantity (FIG. 2).

To fight such a structure heterogeneity, considered as a defect up to now, many studies have been carried out: Guo et al. (Langmuir, 2004, 20, 7789-7793) have established the importance of the solvent in the particle structuring once the deposited drop has dried. Soltman et al. (Langmuir, 2008, 24, 2224-2231) have shown that it is possible to decrease the coffee ring effect by increasing the temperature of the surface where a drop is deposited.

Another method to fight the “coffee ring” phenomenon has been provided by Lim et al. (Adv. Funct. Mater., 2008, 18, 229-234). It comprises adding a solvent having a high boiling point and a low surface tension, thus enabling to promote the appearing of currents called Marangoni currents 7, contrary to convection motions generating the coffee ring. Marangoni currents 7 tend to have the fluid contained in the drop, as well as the particles contained by the drop, migrate towards the center of the drop, due to the surface tension gradient created by the coexistence of the plurality of different solvents in the drop (FIG. 3). FIG. 4 illustrates the appearance of a dried drop 14 which has generated no coffee ring and appears as a substantially circular structure, however of relatively homogeneous thickness.

As a conclusion, the different flows in the drop and the morphology of the residual structure, once the deposited drop has dried, depend on three main factors: the ink, and in particular the nature and the proportion of the solvents, the printing support, and in particular its chemical nature, its temperature, the angle of contact between the ink and the support, and the used printing method, in particular the nozzle diameter, the number of drops, and the drop jet frequency and speed.

Prior improvements of fuel cell electrodes have thus essentially consisted in decreasing the amount of deposited catalyst, to decrease the production cost, and to guarantee a deposit having as few defects as possible. Up to now, this second parameter has comprised avoiding as much as possible the coffee ring phenomenon.

### SUMMARY OF THE INVENTION

The present invention is based on the highlighting of unexpected advantageous properties of electrodes having a structure characteristic of a “coffee ring”, in the context of a fuel cell.

According to the invention, structures characteristic of a coffee ring are defined as being substantially circular structures, having a bead at their periphery.

The substantially circular shape is due to the fact that such structures result from the drying of drops ejected by the DOD inkjet printing device. In practice, the drop size is conditioned by the size of the jet nozzles. Typically, they have an opening in the range between 10 and 100 micrometers, typically in the order of 25 micrometers. Advantageously, the substantially circular structures according to the invention have a size or an external diameter smaller than 1 millimeter (1 mm), advantageously smaller than or equal to 500 micrometers (500 μm), more advantageously still smaller than or equal to 200 micrometers (200 μm). Further, their size is advantageously greater than or equal to 10 micrometers (10 μm), or even 20 micrometers (20 μm). According to a specific embodiment, the structures according to the invention have an external diameter ranging between 20 and 200 micrometers, advantageously equal to 50 micrometers. Functionally, the sizes mentioned for these structures are those enabling to achieve the best current-voltage performance for the electrode thus produced.

Typically, such structures do not have a uniform thickness. More specifically, they exhibit a bead, that is, a thickening, capable of taking the shape of a ring, at their periphery. Such beads are detectable and can be characterized by means of the scanning electron microscopy (SEM) technique or by surface topography measurement.

Advantageously, the bead width represents from 5 to 20% of the size or of the external diameter of the structures. Thus, and as an example:
the bead of a structure having a 20-micrometer diameter advantageously has a width in the range between 1 and 4 micrometers;
the bead of a structure having a 200-micrometer diameter advantageously has a width in the range between 10 and 40 micrometers;
the bead of a structure having a 50-micrometer diameter advantageously has a width in the range between 2.5 and 10 micrometers.

Further, and more advantageously still, such beads have a thickness in the same order as their width, as compared with the very low thickness at the center of the structure. Thus, the thickness at the center may vary between 0.1% and 10% of the bead thickness.

Further, such beads are characterized by their high concentration of matter (catalyst and ionomer). Advantageously, the bead comprises at least 70% by mass of the matter of the structure, or even 80%, or even 90%.

By definition, the structures according to the invention are made of catalyst and advantageously of an ionomer, by the same proportions as in the ink having been used to print these structures.

Typically, the catalyst is platinum. The catalyst is advantageously on a carbon support, such as carbon black. In the case of platinum, it is then called platinum carbon. It further advantageously appears in the form of particles. In adapted fashion, the size of the catalyst particles is smaller than 10 times the diameter of the nozzle opening, which amounts to a maximum particle size smaller than 1 micrometer, or even smaller than 500 nm.

In adapted fashion, the ionomer is a polymer comprising ionic groups, in particular sulphonic groups. It may be a polymer such as PFSA (“Perfluorosulfonic Acid”), in particular, Nafion®.

Thus, and according to a first aspect, the present invention relates to a catalytic layer for a fuel cell, appearing in the form of substantially circular structures comprising a bead at their periphery.

In adapted fashion and in a layer, such structures are spaced apart from one another by a distance greater than or equal to 10 micrometers. In practice, it is a discontinuous layer since, in relation with the DOD inkjet printing technique, the surface to be printed is discontinuously covered with drops which, by drying, will provide the desired structures.

According to a specific embodiment in relation with the successive deposition of several layers of drops, the catalytic layer according to the invention may be made of a stack of layers of a structure according to the invention. In practice, structures of substantially circular shape comprising a bead at their periphery may overlap or stack.

As already mentioned, the structures according to the invention form on the printed surface. In the context of fuel cells, the printed surface advantageously is the electrolytic membrane or a gas diffusion layer (GDL).

Thus, and according to another aspect, the invention aims at an electrolytic membrane for a fuel cell having, on at least one of its surfaces, structures of substantially circular shape comprising a bead at their periphery, or even a stack of such structures.

Such a membrane is advantageously made of the same ionomer as that present in the structures, advantageously a PFSA-type polymer such as Nation®. In preparation for the forming of a MEA, the electrolytic membrane may have such structures on each of its surfaces.

According to another aspect, the invention aims at gas diffusion layer for a fuel cell having, on at least one of its surfaces, substantially circular structures comprising a bead at their periphery, or even a stack of such structures. According to a preferred embodiment, each of the two gas diffusion layers of a fuel cell has on one of its surfaces, advantageously that directed towards the electrolytic membrane, structures such as defined hereabove.

Conventionally, a gas diffusion layer is a support containing carbon black.

Advantageously, the catalyst load, and in particular, the platinum load, at the surface of the membrane or of the gas diffusion layer, is in the range between 0.1 and 0.3 mg/cm².

According to a specific embodiment, the catalyst load may be greater for the cathode (which may represent approximately ⅔ of the total catalyst load) than for the anode (which may represent approximately ⅓ of the total catalyst load).

Another aspect of the invention relates to a fuel cell comprising at least a catalytic layer according to the invention and/or an electrolytic membrane according to the invention and/or a gas diffusion layer according to the invention. Unexpectedly and as demonstrated in the context of the present application, such a fuel cell has an improved performance as compared with a cell which does not have this type of structures.

As already mentioned, an important criterion for the forming of structures characteristic of a “coffee ring” is the composition of the ink used to print the drops generating such structures. The present invention thus aims at an ink which, when deposited by DOD inkjet printing, generates substantially circular structures comprising a bead at their periphery, characteristic of a coffee ring.

It has been shown, in the context of the invention, that a low content of humectant, in particular of polyol, in the ink would promote the appearing of a coffee ring while its presence used to be considered indispensable by those skilled in the art to avoid the clogging of the jet nozzles, who in any event did not try to promote the coffee ring phenomenon.

Thus, advantageously, an ink used in the context of the invention comprises a mass proportion of humectant, advantageously of polyol, smaller than or equal to 7%, or even smaller than or equal to 6%. Further, and even if it may be zero, its mass proportion is advantageously greater than or equal to 2%, or even greater than or equal to 3%. In a preferred embodiment, the mass proportion of humectant, advantageously, a polyol, more advantageously still ethylene glycol, amounts to from 5 to 6% of the ink, for example, 5.3%.

The humectant according to the invention advantageously is a polyol or a diol such as ethylene glycol (or glycol), polyethylene glycol, or propylene glycol.

Conventionally, an ink according to the invention further comprises a catalyst, an ionomer, and a solvent system comprising water advantageously associated with an alcohol. The catalyst and the ionomer are defined as hereabove in relation with the obtained structures.

Advantageously and at the indicated mass concentrations, alcohol enables to increase the wetting surface area of the ink deposited on the surface to be printed and to decrease the angle of contact between the drop and the printed surface. A larger wetting surface area and a smaller angle of contact enable to increase the accuracy of the drop positioning on the printed surface.

The alcohol advantageously is isopropanol, ethanol, or propanol, and more advantageously still isopropanol.

In addition to the proportions indicated hereabove for the humectant, advantageously, polyol, the other components of the ink according to the invention preferably have the following mass proportions:
between 1.5% and 3.5% of catalyst, advantageously 2.3%; and/or
between 2.5% and 5% of ionomer (with a 22% dry mass percentage), advantageously 3.4%; and/or
between 50% and 85% of water, advantageously 69%; and/or
between 10% and 40% of alcohol, advantageously 20%.

The mass percentage indicated for the ionomer corresponds to the mixing of the ionomer with a solvent, in the case where the ionomer represents 22% of the dry mass of the mixture. In the case of another presentation of the ionomer, in particular with another dry mass percentage, it will be within the abilities of those skilled in the art to determine, by conversion, the quantity to be introduced.

As already mentioned, the catalyst advantageously appears in the form of a catalyst supported on carbon.

Such concentration ranges, taken individually or combined, correspond to ranges optimized to generate structures according to the invention, in other words, to promote the coffee ring phenomenon during the drying of the printed ink drops.

According to another aspect, the invention thus relates to the use of such an ink to generate substantially circular structures comprising a bead at their periphery, after drying of ink drops.

In adapted fashion, such an ink, and more generally any ink generating the desired structures in the context of the invention, is used in an drop-on-demand or DOD-type inkjet printing method. In other words, the invention aims at the use of an ink generating substantially circular structures comprising a bead at their periphery, advantageously of an ink such as described hereabove, for the DOD inkjet printing of the catalytic layer of a fuel cell. Such a printing is advantageously performed on the electrolytic membrane or on the gas diffusion layer (GDL).

As appears from the present application, such a cell has an improved electrochemical performance. Accordingly, and according to another aspect, the invention relates to the use of an ink generating substantially circular structures comprising a bead at their periphery, advantageously of an ink such as described hereabove, to improve the performance of a fuel cell.

According to another aspect, the invention thus relates to a method of depositing, by drop-on-demand (DOD) inkjet printing, the catalytic layer of a fuel cell comprising the deposition, on a printing surface, of an ink generating substantially circular structures comprising a bead at their periphery.

As already mentioned, the printing surface advantageously is the electrolytic membrane or the gas diffusion layer of a fuel cell.

Conventionally, and in relation with a drop-on-demand or DOD inkjet printing method, the implemented method comprises the steps of:
expelling the ink drops through a printing nozzle towards the printing surface;
drying the deposited drops, advantageously at a temperature greater than or equal to 40° C.

Conventionally, the ink is contained in a reservoir.

Appropriately, only the drops necessary to the printing are formed and expelled. Advantageously, the process of drop expelling towards the printing surface is carried out by the activation of a piezoelectric or thermal element.

As already mentioned, the printing surface may be the surface of the electrolytic membrane or that of a gas diffusion layer.

Advantageously, the nozzles have an opening of a size in the range between 10 and 100 micrometers, for example, 25 micrometers.

Further, the method is optimized by drying the drops at a temperature greater than 20° C., advantageously greater than or equal to 40° C., or even in the order of 60° C., which further promotes the coffee ring phenomenon. Advantageously, it is the temperature to which the support or the printing surface is taken.

The DOD inkjet printing method may advantageously be repeated several times in a row, to form a stack of layers structured by the coffee ring. Advantageously, the drops are expelled when the previously-deposited drops are dry.

### BRIEF DESCRIPTION OF THE DRAWINGS

The present invention will be better understood on reading of the following description provided as an example only in relation with the accompanying drawings, where the same reference numerals designate the same or the like elements, among which:

FIG. 1 is a simplified cross-section view of a coffee-ring-generating ink drop deposited on the printed surface.

FIG. 2 is a SEM view (A) or a simplified perspective view (B) of a dried ink drop having the coffee ring characteristics.

FIG. 3 is a simplified cross-section view of an ink drop which does not promote the coffee ring generation, deposited on the printed surface.

FIG. 4 is a SEM view (A) or a simplified perspective view (B) of a dried ink drop which does not have the coffee ring characteristics.

FIG. 5 is a simplified cross-section view of a printing head of a DOD inkjet printer used in the context of the present invention.

FIG. 6 is a SEM view of drops of an ink according to the invention, deposited on a GDL (A) or on a Nafion® membrane (B), dried at the indicated temperatures (20° C., 40° C., and 60° C., respectively).

FIG. 7 compares the performance in a fuel cell of an electrode with no coffee ring and of an electrode where the coffee ring phenomenon occurs according to the invention.

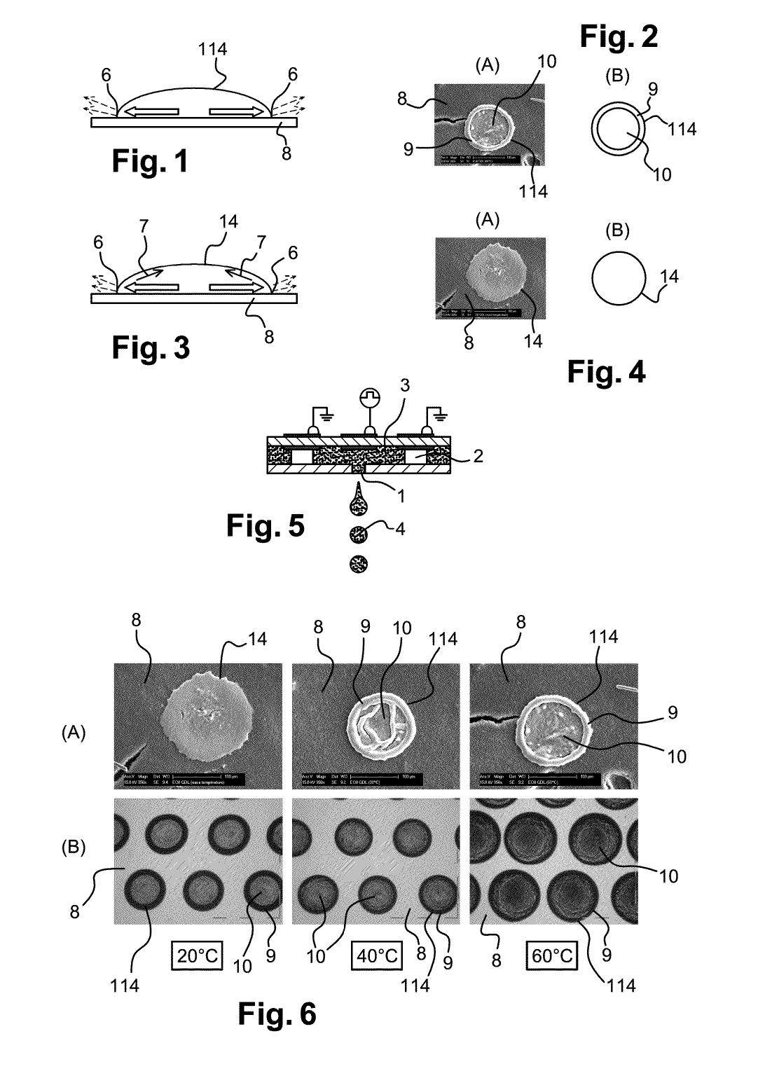

Some elements of the drawings have been enlarged to make their understanding easier and they may accordingly be out of scale.

### DETAILED DESCRIPTION

To form fuel cell electrodes having an improved performance and a low production cost, the invention has shown the advantage of promoting the coffee ring effect to structure said electrodes and an ink adapted to the forming thereof.

1/Ink Definition:

The ink used to form the electrode which is the object of the invention should be compatible with drop-on-demand or DOD-type inkjet printers. FIG. 5 illustrates a printing head of such an inkjet printer. The printing head in particular comprises a nozzle 1, through which the ink comes out in the form of drops 4. The drop size (or diameter) thus depends, in particular, on the nozzle opening. The expelling of a drop 4 may be caused in different ways. In FIG. 5, the application of an electric signal to piezoelectric elements 2 causes a slight contraction of the reservoir containing ink 3 in the printing head. There also exist other technologies enabling to accurately control the expelling of a drop by the nozzle of an inkjet printer. It is thus possible to use a heating element to form bubbles in the reservoir containing the ink, modifying the pressure in the reservoir and thus forcing a few picoliters of ink to be expelled by the nozzle in the form of drops. It is also possible to apply acoustic waves to the reservoir containing the ink or also an electrostatic field to expel a drop.

An ink particularly capable of generating coffee rings has the following composition by weight:
catalyst, advantageously platinum carbon, more advantageously still TEC10V50E (Tanaka), comprising 50% by mass of platinum on a carbon support: 2.3%;
ionomer, advantageously Nafion®, more advantageously still DE2020 (Dupont): 3.4% (the ionomer representing a 22% dry mass percentage);
water: 69%;
alcohol, advantageously isopropanol (IPA): 20%;
polyol, advantageously ethylene glycol (EG): 5.3%.

In parallel, an ink generating no coffee ring has been tested. It has the following composition. It is the same formulation as hereabove, with, however, a mass proportion of polyol, advantageously of ethylene glycol, equal to 30%.

2/Ink Printing:

The ink having the composition just described is used in a DOD inkjet printer capable of depositing fuel cell catalytic layers, on the electrolytic membrane or on GDLs, as illustrated in FIG. 5.

Among important parameters to perform a catalyst deposition ensuring a good electrode performance, it is advantageous to select the nozzle size, which conditions the size of the expelled drops, and thus the size of the obtained coffee ring structures 114, as well as the temperature to which the printed surface, that is, the polymer membrane or a GDL 8, is taken.

Thus, a nozzle 1 having an opening of dimensions in the range between 10 and 100 micrometers provides advantageous results in terms of performance of the obtained electrodes. With such nozzles 1, structure having a diameter in the range between 20 and 200 micrometers are obtained on the printed electrode, once the drop having caused these structures has dried (FIG. 2B). Advantageously, a nozzle 1 of intermediate size, having a 25-micrometer opening, will be selected. Such a size of nozzle 1 enables to obtain coffee rings 114 on the printed electrode having an external diameter of 50 micrometers.

It has also been demonstrated that a temperature greater than 20° C. enables to promote the occurrence of coffee ring phenomenon 114. Advantageously, surface 8 on which ink drops 4 are deposited is taken to a temperature of 40° C., or even 60° C. (FIG. 6).

After drying, it is possible to print a new ink drop layer.

3/Description of the Obtained Structured Electrodes:

The aim of the user of an ink enhancing the coffee ring phenomenon is to structure the surface of an electrode by means of structures of substantially circular shape having a bead or ring 9 at their periphery, called coffee rings 114. Such structures can in particular be observed by scanning electron microscopy (SEM) or by surface topography measurement.

In adapted fashion, such structures characteristic of coffee ring 114 are as shown in FIG. 2, with an external diameter in the range between 20 and 200 micrometers, advantageously equal to 50 micrometers.

Further, and as illustrated in FIG. 6, the spacing between two structures is advantageously greater than or equal to 10 micrometers.

The optimal structure of a coffee ring 114, like that shown in FIG. 2B, is comprised of a peripheral ring with a strong catalyst concentration (at least 70% by mass, or even 90% by mass of the matter), thus forming a circular bead 9 having a width (also corresponding to its thickness) from 5 to 20% of the external diameter of coffee ring 114, advantageously 10%. The inside of ring 10 is mostly catalyst-free and has a very small thickness.

Conversely, the ink described hereabove containing 30% of ethylene glycol generates structures such as that shown in FIG. 4.

4/Fuel Cell Performances:

As already mentioned, such a printing may be performed on the membrane (CCM for an ink deposition on a membrane) as well as on the gas diffusion (CCB for an ink deposition on a GDL). After printing, the MEA is assembled by hot pressing, typically at a temperature equal to 135° C.

A current-voltage study has compared the performance of electrodes obtained from the two above-described inks, that according to the invention generating coffee rings and that according to prior art being formulated to avoid the occurrence of coffee rings.

In practice, the same catalyst has been deposited by means of the same DOD inkjet method.

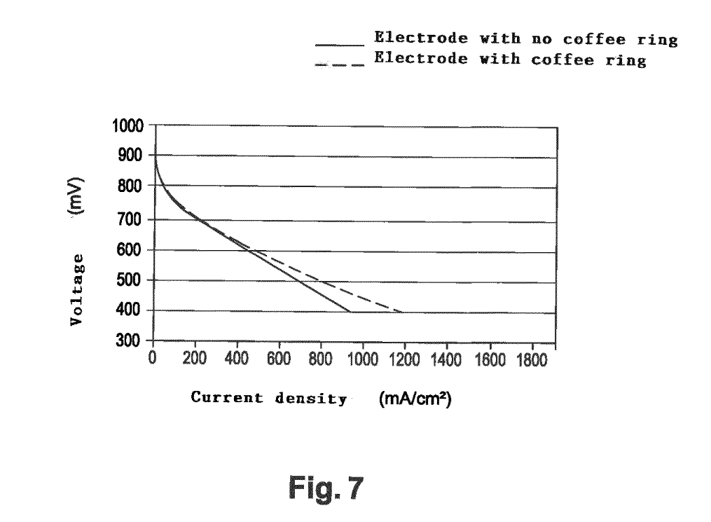

As illustrated in FIG. 7, this study has shown that the structuring of fuel cell electrodes in the form of the structure characteristic of coffee ring 114, that is, substantially circular structures having a bead 9 at their periphery, enables to generate a current density, at a fixed voltage, greater than that observed in electrodes having no structures characteristic of a coffee ring, in particular at a high current density.

As a conclusion, the structured electrodes according to the invention have the same advantages in terms of production costs and of forming techniques as electrodes with no coffee ring, while having a better current-voltage performance.

1. A method of deposition, by drop-on-demand (DOD) inkjet printing, of a catalytic layer of a fuel cell comprising depositing, on a printing surface, an ink generating substantially circular structures comprising a bead at their periphery.

2. The deposition method of claim 1, wherein the printing surface is an electrolytic membrane or a gas diffusion layer of the fuel cell.

3. The method of claim 1, wherein it comprises the steps of:
expelling ink drops through a printing nozzle, advantageously having an opening with a diameter in the range between 10 and 100 micrometers, towards the printing surface;
drying the deposited drops, advantageously at a temperature greater than or equal to 40° C.

4. The deposition method of claim 3, according to which the steps of expelling the drops towards the printing surface and of drying are iteratively repeated.

5. A catalytic layer for a fuel cell capable of being obtained by means of the method of claim 1, appearing in the form of substantially circular structures comprising a bead at their periphery and having an external diameter smaller than 1 millimeter, advantageously in the range between 20 and 200 micrometers.

6. The catalytic layer for a fuel cell of claim 5, wherein the structures have an external diameter equal to 50 micrometers.

7. The catalytic layer for a fuel cell of claim 5, wherein the width of the beads of the structures represents from 5 to 20% of the external diameter of the structures.

8. The catalytic layer for a fuel cell of claim 6, wherein the width of the heads of the structures represents from 5 to 20% of the external diameter of the structures.

9. The catalytic layer for a fuel cell of claim 5, wherein the structures are spaced apart from one another by a distance greater than or equal to 10 micrometers.

10. An electrolytic membrane for a fuel cell having on at least one of its surfaces, structures such as defined in claim 5.

11. A gas diffusion layer for a fuel cell having on at least one of its surfaces, structures such as defined in claim 5.

12. A fuel cell comprising the catalytic layer of claim 5.

13. A fuel cell comprising the electrolytic membrane of claim 9.

14. A fuel cell comprising at least one gas diffusion layer of claim 10.
